(19) United States
(12) Patent Application Publication
(10) Pub. No.: US 2008/0136796 A1
(43) Pub. Date: Jun. 12, 2008

(54) METHODS AND APPARATUS FOR DISPLAYING IMAGES ON A MOVING DISPLAY UNIT

(75) Inventor: Kevin J. Dowling, Westford, MA (US)

Correspondence Address: WOLF GREENFIELD & SACKS, P.C., 600 ATLANTIC AVENUE, BOSTON, MA, 02210-2206, US

(73) Assignee: Philips Solid-State Lighting Solutions, Burlington, MA (US)

(21) Appl. No.: 11/943,029

(22) Filed: Nov. 20, 2007

Related U.S. Application Data
(60) Provisional application No. 60/866,444, filed on Nov. 20, 2006.

(51) Int. Cl. G09G 5/00

(52) U.S. Cl. 345/204; 345/46

(57) ABSTRACT

Methods and apparatus for maintaining displayed imagery stationary relative to the physical surroundings when the imagery is displayed on a display device which moves (e.g., translates and/or rotates) relative to the physical surroundings. To maintain an image's position relative to the physical surroundings, the position of the display device may be directly measured or otherwise tracked, and the position of the imagery as displayed on the display device adjusted accordingly.

### CROSS-REFERENCE TO RELATED APPLICATION

The present application claims the benefit, under 35 U.S.C. §119(e), of U.S. provisional application Ser. No. 60/866,444, filed Nov. 20, 2006, and entitled “Methods and Systems for a Tracking Display,” which application is hereby incorporated herein by reference.

### FIELD OF THE INVENTION

The inventive subject matter disclosed herein generally relates to image display devices, and, more particularly, to methods and apparatus for adjusting the position and/or orientation of images displayed on a display device that moves (e.g., is translated and/or rotated) with respect to a reference frame.

### BACKGROUND

Numerous image display devices exist, such as, for example, CRT monitors, LCD panels, plasma screens, and fabrics or other materials with incorporated LEDs. Increasingly, various display devices are lightweight and capable of being used in situations where the display devices are actively moved while displaying images. For example, various entertainment venues use LED backdrops which are large pieces of fabric including a grid of LED nodes interconnected by thin wires. The backdrops provide an efficient manner of displaying large images, and advantageously, can be easily moved in many circumstances.

### SUMMARY

One embodiment of the present invention is directed to a method of displaying an image on a display unit. In this method, the image is (i) in a first image position relative to a reference frame that is external to the display unit and (ii) in a first image orientation relative to the reference frame. Also, the display unit is in a first display unit position and a first display unit orientation relative to the reference frame. The method further includes moving the display unit to a second display unit position and/or a second display unit orientation relative to the reference frame. Further, as part of this method, the second display unit position and/or the second display unit orientation is determined and then, based on the second display unit position and/or orientation, a target position and/or a target orientation for at least a portion of the image relative to the display unit is calculated such that in the target position and/or the target orientation, the at least a portion of the image remains substantially in the first image position and/or the first image orientation relative to the reference frame. The method further includes displaying the at least a portion of the image on the display unit in the target position and/or the target orientation.

In some implementations, moving the display unit to a second display position and/or a second display orientation includes moving the display unit to a second display position, determining the second display position and/or the second display orientation comprises determining the second display position, and calculating a target position and/or target orientation for the at least a portion of the image comprises calculating a target position for the at least a portion of the image.

In some implementations, moving the display unit to a second display position and/or a second display orientation includes moving the display unit to a second display orientation, determining the second display position and/or the second display orientation includes determining the second display orientation, and calculating a target position and/or target orientation for the at least a portion of the image includes calculating a target orientation for the at least a portion of the image. This method may include directly sensing the second display position and/or the second display orientation as part of determining the second display position and/or second display orientation.

In some implementations, this method may include using dead-reckoning as part of determining the second display position and/or second display orientation. The display unit may be a large, substantially flat piece of material and a plurality of separately controllable LEDs attached to the piece of material in some implementations. Moving the display unit to a second display unit orientation may include rotating the display unit about an axis that is substantially perpendicular to the display unit. Also, moving the display unit to a second display unit orientation may include rotating the display unit about an axis that is either parallel to the display screen or contained substantially within the display screen. The image may be a subset of a larger virtual image in some implementations. Further, in some implementations, calculating a target position and/or a target orientation for at least a portion of the image relative to the display unit includes calculating a target position and/or a target orientation for the entire image, and displaying the at least a portion of the image on the display unit in the target position and/or the target orientation includes displaying the entire image.

Another embodiment of the present invention is directed to a system for displaying an image. The system comprises a display unit and a controller coupled to the display unit and configured to instruct the display unit to display an image such that the image remains in substantially a same position and/or orientation, relative to physical surroundings of the display unit, notwithstanding a movement of the display unit relative to the physical surroundings.

Another embodiment of the invention is directed to a method of displaying an image, the method comprising: A) storing information regarding an image to be displayed, wherein an image position and/or image orientation is determined with respect to a fixed reference frame; and B) progressively displaying different portions of the image, based at least in part on the stored information, via a display unit that is moving with respect to the fixed reference frame, wherein the image position and/or image orientation remains unchanged with respect to the fixed reference frame.

The following applications and patent are hereby incorporated by reference:
U.S. Pat. No. 6,717,376, issued Apr. 6, 2004, entitled “Methods and Apparatus for Controlling Devices in a Networked Lighting System;”
U.S. patent application Ser. No. 10/995,038, filed Nov. 22, 2004, entitled “Light System Manager;”
U.S. patent application Ser. No. 11/070,870, filed Mar. 14, 2005, entitled “Entertainment Lighting System;” and
U.S. patent application Ser. No. 11/081,020, filed on Mar. 15, 2005, entitled “Methods and Systems for Providing Lighting Systems.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIGS. 1a-1c illustrate a display system according to one embodiment of the present invention;

FIG. 2 is a flowchart of a method of displaying an image according to one embodiment of the present invention;

FIG. 3 is an illustration of a computer-implemented display system according to one embodiment of the present invention; and

FIG. 4-8 illustrate exemplary applications of methods and apparatus according to various embodiments of the present invention.

### DETAILED DESCRIPTION

Following below are more detailed descriptions of various concepts related to, and inventive embodiments of, methods, apparatus and systems according to the present disclosure for displaying images on a moving display unit. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

Various embodiments of the present invention are directed to methods, apparatus and systems for maintaining displayed imagery stationary relative to the physical surroundings (e.g., a fixed reference frame) when the displayed imagery is displayed on a display device which moves relative to the physical surroundings of the display device. Such a display apparatus in which an image position and/or orientation remains unchanged with respect to a fixed reference frame, notwithstanding movement of the display apparatus relative to the fixed reference frame, is referred to herein as a “tracking display.” To maintain an image's position relative to the physical surroundings, the position of the display device is measured or estimated and the position of the image on the display device is adjusted accordingly. For example, a large video screen suspended on a back wall of a room may display a small photograph in the middle of the video screen such that the photograph is positioned one meter above the floor of the room and one meter from the adjacent wall. As the video screen is moved up, down, left or right, the position of the photograph on the video screen is adjusted relative to the video screen such that the photograph remains one meter from the floor of the room and one meter from the adjacent wall. In other words, when the display devices move, the displayed images remain stationary relative to the physical surroundings in the sense that the images are displayed in the same position that they would have been displayed without any movement of the display device. The displayed imagery itself, however, may include both static and dynamic elements, for example, animation.

For purposes herein, the term “position” means location, and “changing the position” of an element or “moving the element to a new position” means translating the element. A change in position may also or alternatively include a change in orientation and still be considered a change in position. Unless otherwise specified, as applied to a two-dimensional display device or image, a change in orientation may include a rotation within the plane of the display device or the image, or the rotation may be out of plane.

In some embodiments of the present invention, the display device may be moved by a mechanical actuator or other suitable methods of providing controlled movement. In other embodiments, the display device may experience unpredictable or uncontrolled movements, such as movement by a person or movement created by wind or other exterior forces. By tracking the position and/or orientation of the display device, the displayed imagery may be held in a constant position and/or orientation relative to the physical surroundings.

The physical surroundings of the display device may be any suitable three-dimensional reference frame that encompasses at least a portion of the display device. For example, a plasma screen movable on a wall of a room may be used, and, in this implementation, any one wall of the room may be considered to establish one plane of a fixed three-dimensional reference frame. In another example, an LED-containing backdrop may be suspended at an outdoor concert arena, and the ground may be considered to establish one plane of a fixed three-dimensional reference frame. In still a further embodiment, a video display may be mounted inside a movable physical environment such as a flight simulator, and the three-dimensional reference frame may be exterior to the flight simulator. In some embodiments, it should be appreciated that a plane of the physical surroundings or a given environment in which a display unit is disposed in not necessarily required to establish a reference frame, nor does any axis of a reference frame need to be established by a physical feature of the environment/surroundings; more generally, any arbitrary reference frame for the display unit/image to be displayed, of various dimensions (e.g., one, two, or three dimensions) may be established, as long as both the actual position and/or orientation of the display unit at a given time, as well as the perceived position and/or orientation of an image to be displayed, may be compared to each other and the reference frame.

Display systems and methods according to various inventive embodiments disclosed herein may be useful in a variety of applications, for example, in conjunction with an LED-containing backdrop at an entertainment venue to hold images steady as the backdrop moves. In one exemplary implementation, as the backdrop is lowered from above, a stationary image may be progressively displayed from top to bottom. This arrangement contrasts with conventional setups in which a lowered backdrop displays an image that moves downwardly and is progressively visible from bottom to top. In another implementation, as the backdrop is moved by air currents, the image may be adjusted so that it continues to appear stationary.

In other exemplary implementations, methods and systems according to various embodiments of the present invention may be useful for locating components positioned behind opaque surfaces. For example, a plurality of pipes, valves and other plumbing components may be hidden behind the wall of a building, and it may be desirable to know the location of a valve before cutting a hole in the wall for inspection or repair. When the plumbing is initially installed, the locations of various components may be mapped relative to a reference point or a reference frame, and the information may be stored electronically as an overall image of features behind a wall over a given area. After the wall is installed, a display device, such as a portable plasma or LCD screen, may be loaded with the location data, and as the display device is passed over the wall, relative to the reference frame for the location data, the appropriate pipes or other components are shown on the display device. In this manner, employing a display device that may be substantially smaller in dimensions than the wall to be scanned, the display device provides a moveable “window” that allows “viewing” through the opaque wall of the image features at corresponding locations behind the wall.

Similarly, a display device, such as a portable and/or hand held video screen, could be moved over a surgical patient and data garnered from an x-ray or MRI may be displayed as the display device is moved over the patient, thereby providing a virtual “window to the inside” of the patient. The display of the imagery may be adjusted for out-of-plane rotations of the video screen. In this manner, even if the user tilts the video display, the images projected toward the user would not change.

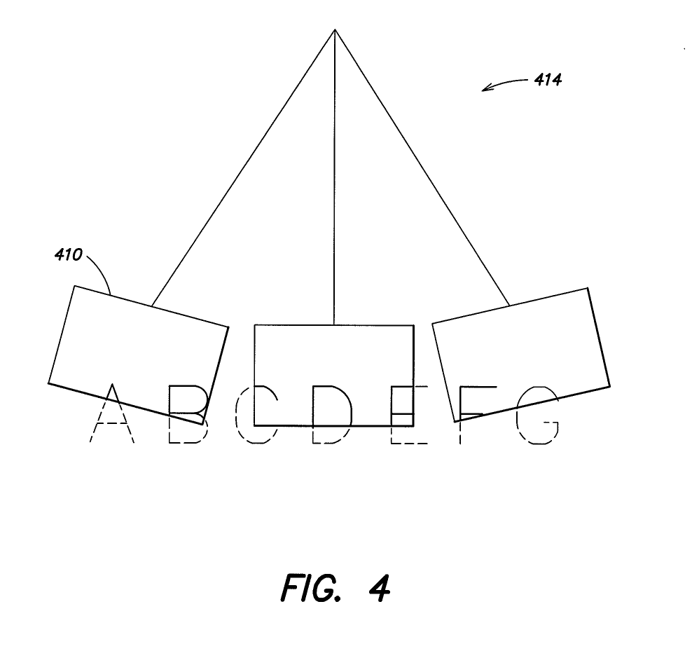

More generally, the applications discussed immediately above are examples of displaying portions of a “virtual” image that is larger than the display device itself. For example, all of the data representing the imagery of pipes behind a wall may be displayable at a 1:1 ratio for a wall that is 10 ft.×10 ft. If a display device that is 1 ft. square is used to view the pipes, only a portion of the overall “virtual” image will be viewable at a given time. In other examples, visual effects may be created by displaying portions of a virtual image. For example, a display device may be moved as a pendulum, displaying portions of the image as the device swings (discussed further below in connection with FIG. 4).

Any suitable display device may be used with the systems and methods described herein without deviating from the spirit and scope of the present invention. In addition to the display devices mentioned above, some non-limiting examples of suitable devices include various light-projecting displays, such as LED arrays, cathode ray tube monitors, and DLP monitors, as well as display devices employing reflective technologies, such as electrophoretic displays.

According to one exemplary embodiment, to accurately reposition an image on a display device when the device is moving or has moved, the position and/or orientation of the display device are determined at different times (e.g., periodic intervals), and the position/orientation information is provided to a controller, which performs the appropriate calculations and implements any necessary repositioning of the image on the display device. Various schemes for measuring or estimating the position and/or orientation of the display device relative to some reference frame may be used. In some embodiments, a “dead-reckoning” process is employed to establish the position of the display device. With dead-reckoning, to determine a current or future position of a display device, an initial, known position of the display device is used in conjunction with measured or controlled movements of the mechanical components that move the display device. For example, in a system that includes a curtain supported by cables that are wound by an electric motor, the current position of the curtain may be calculated by measuring the amount of time that a given motor is turned on, and combining this information with an initial position of the curtain.

Another option for tracking the movements of a display device according to various embodiments includes directly sensing the display device or associated markers to determine the position and/or orientation of the display device. Examples of various types of sensors that may be used include mechanical sensors, optical sensors, magnetic sensors, acoustic sensors, encoders and clinometers.

Whether sensing the display device position/orientation, providing data calculated when using dead-reckoning, or otherwise estimating device position/orientation, a rate at which position/orientation information is updated (i.e., a “sample rate” for such information) may be substantially continuous so that the image is constantly adjusted to maintain its stationary position. For example, the sample rate may match the refresh frequency of the display device. It should be appreciated that the invention is not limited in this respect, however, as a variety of different sample rates/times may be suitable for different implementations.

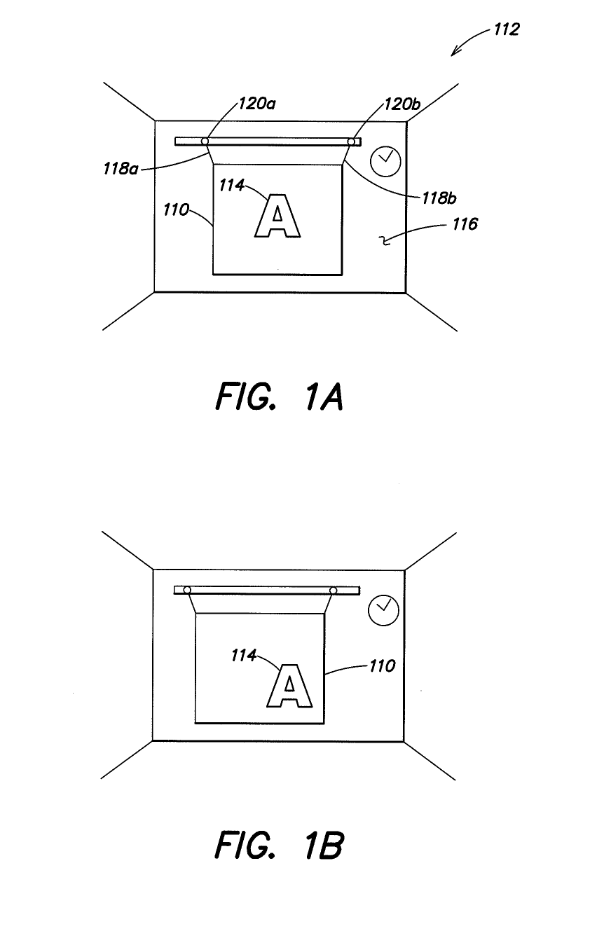

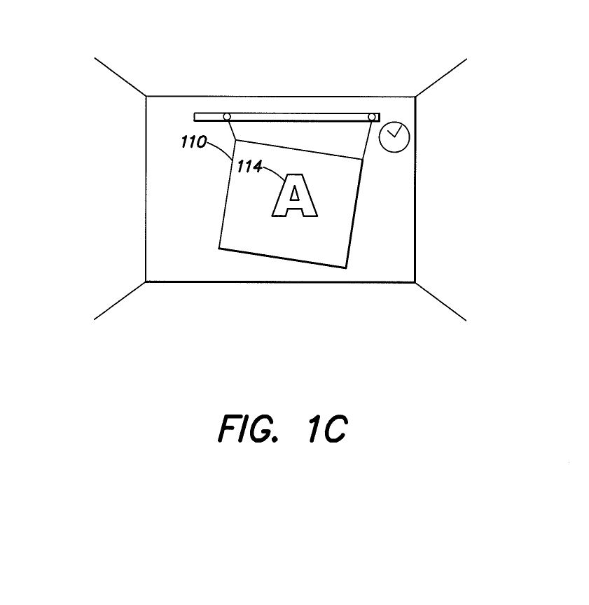

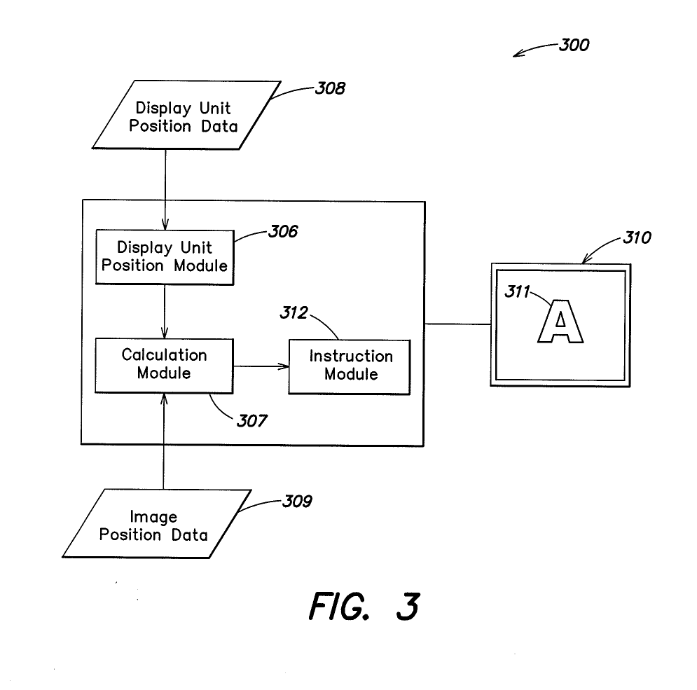

FIGS. 1a and 1b illustrate the translation of a display device (or “display unit”), such as a thin-screen video monitor 110, within a room 112, while maintaining a displayed image 114 in the same position relative to room 112. Video monitor 110 is suspended on a wall 116 with cables 118a, 118b that are attached to movable blocks 120a, 120b. FIG. 1a shows video monitor 110 and displayed image 114 in an initial state. As blocks 120a, 120b move toward the left side of the room, video monitor 110 follows (see FIG. 1b). A controller (not shown in FIGS. 1a-1c) determines the position of video monitor 110, and adjusts the display of displayed image 114 so that its position remains stationary relative to room 112. As discussed further below in connection with FIG. 3, the controller may be disposed within video monitor 110, or may be located remotely and communicate with video monitor 110 through a wired or wireless connection (e.g., communication link).

A change in the orientation of video monitor 110 (relative to FIG. 1a) is shown in FIG. 1c. To rotate video monitor 110, additional cable is unwound from block 120b. As video monitor 110 rotates, the controller determines the orientation of video monitor 110 and redisplays displayed image 114 accordingly. In some implementations, video monitor 110 is translated and rotated simultaneously, and the controller adjusts both the position and orientation of displayed image 114 to maintain its original display position and orientation relative to room 112. In other implementations, even though video monitor 110 may be both translated and rotated, the system adjusts only one of the position and orientation of displayed image 114. The user may select whether the position and/or orientation of displayed images are to be held constant relative to the physical surroundings during movement of the display device.

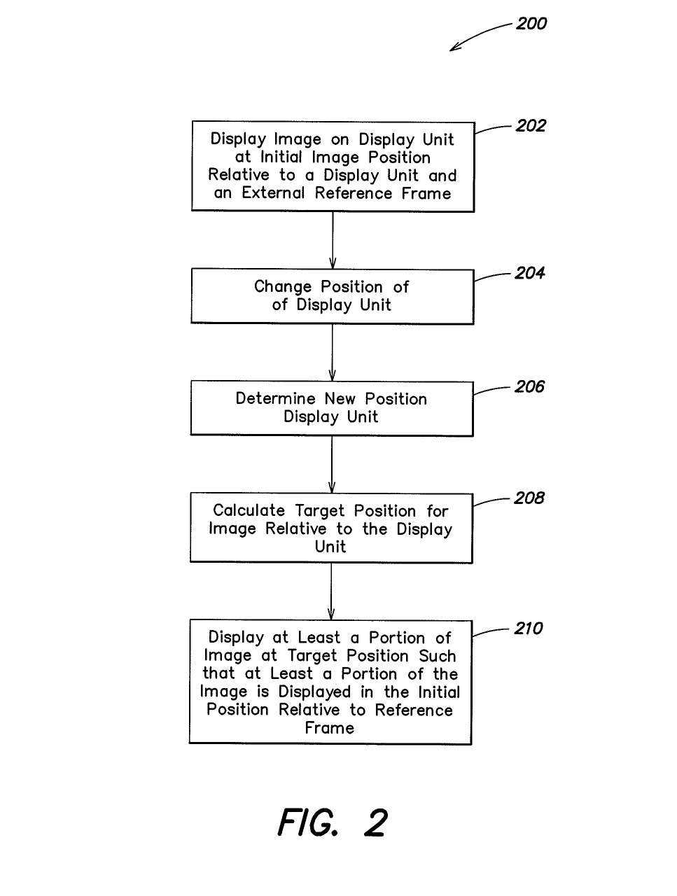

Referring to a flowchart shown in FIG. 2, in one embodiment of a method 200 for displaying an image, a displayed image is held in constant position relative to the physical surroundings. Additional acts, such as holding the displayed image orientation constant relative to the physical surroundings, are contemplated by the present invention and may be added to method 200.

In an act 202, an image is displayed on a display unit at an initial (first) image position relative to a reference frame (e.g., a wall in a room) that is external to the display unit. In an act 204, the position of the display unit is changed to a new (second) position. The new position of the display unit is determined in an act 206. This determination of the new display unit position may be accomplished by directly measuring the new position, for example, by sensing the position of reference markers. In some implementations, the determination of the new position is performed by tracking or controlling the movements of the support structure (e.g., blocks and cables) for the display unit and then determining the position of the display unit relative to an initial position based on these movements, or otherwise estimating position and/or orientation.

Based on the new (second) display unit position, a target position for the image relative to the display unit is calculated in an act 208. The target image position is calculated such that when the image is displayed on the display unit in an act 210, at least a portion of the image will be displayed in the initial image position relative to the reference frame.

In various implementations, the entire displayed image is displayed with the display unit in the new position. In some circumstances, however, the display unit may move too far to permit display of the entire displayed image in its initial position. In such circumstances, a portion of the image may maintain its position relative to the reference frame, but the remainder of the image may not be displayed.

Calculations to correctly position and/or orient images on the display unit may involve matrix transformation and homogeneous transforms, which are well known to those of ordinary skill in the art. Descriptions of such calculations are readily available in Introduction to Robotics Mechanics and Control by John J. Craig (3^{rd} ed. 2003) and Root Manipulators: Mathematics, Programming and Control by Richard P. Paul (MIT Press 1981), both texts being incorporated by reference herein.

FIG. 3 shows an exemplary implementation of an image display system 300, according to one embodiment of the present invention, in which the system includes a controller 302 and a display unit 310. While the controller 302 is illustrated separately from the display unit 310, it should be appreciated that various configurations for the controller and display unit are contemplated by the present invention, including implementations in which the controller is included within a housing for the display unit or is a separate unit from the display unit. In various aspects, controller 302 may include three modules, each of which may be a software, hardware or firmware module, or some combination thereof. Examples of specific structure and/or organization of modules in connection with FIG. 3 is provided primarily for purposes of illustration, and the invention is not limited to the particular components and arrangement of components shown in FIG. 3.

In one embodiment of the system 300, controller 302 includes a display unit position module 306 which receives data 308 regarding the position and/or orientation of display unit 310. The data provided to display unit position module 306 may include sufficient information for module 306 to directly pass the data to an image position calculation module 307. In some implementations, however, display position data 308 may require manipulation or module 306 may require further information to provide sufficient information to calculation module 307. In one example, a GPS system may be used to gather data regarding the position and/or orientation of display unit 310.

Image position calculation module 307 also receives as input image position data 309 and calculates the appropriate target position and/or orientation of the image to be displayed on the display unit based on the determined position and/or orientation of the display unit 310 relative to a reference frame. This information is passed to an instruction module 312 which controls the display of the image on display unit 310.

It should be appreciated that any single component or collection of multiple components of a computer system that perform the functions described above can be generically considered as one or more controllers that control the above-discussed functions. The one or more controllers can be implemented in numerous ways, such as with dedicated hardware, or by using a processor that is programmed using microcode or software to perform the functions recited above. One or more of the components of system 300 may reside on a single system, or one or more components may reside on separate, discrete systems. Further, each component may be distributed across multiple systems, and one or more of the systems may be interconnected.

FIG. 4 shows a single display unit 410 being swung as a pendulum. Each of three positions of display unit 410 as shown in FIG. 4 represents the display unit's position at a different time. In each position, display unit 410 shows a different portion of a “virtual” image 414 that is larger than display unit 410. The portions of the image shown in solid lines represent the portions of the image displayed by the display unit in the various illustrated positions, while the dashed lines represent the portions of the image that are not displayed by display unit 410 in any of these three positions. With display unit 410 in motion, virtual image 414 appears as a stationary image with portions thereof progressively exposed by display unit 410. The pendulum aspect of the system illustrated in FIG. 4 is a good example of a system which also adjusts the orientation of displayed images to maintain the orientation of an image, while the orientation of the display unit changes.

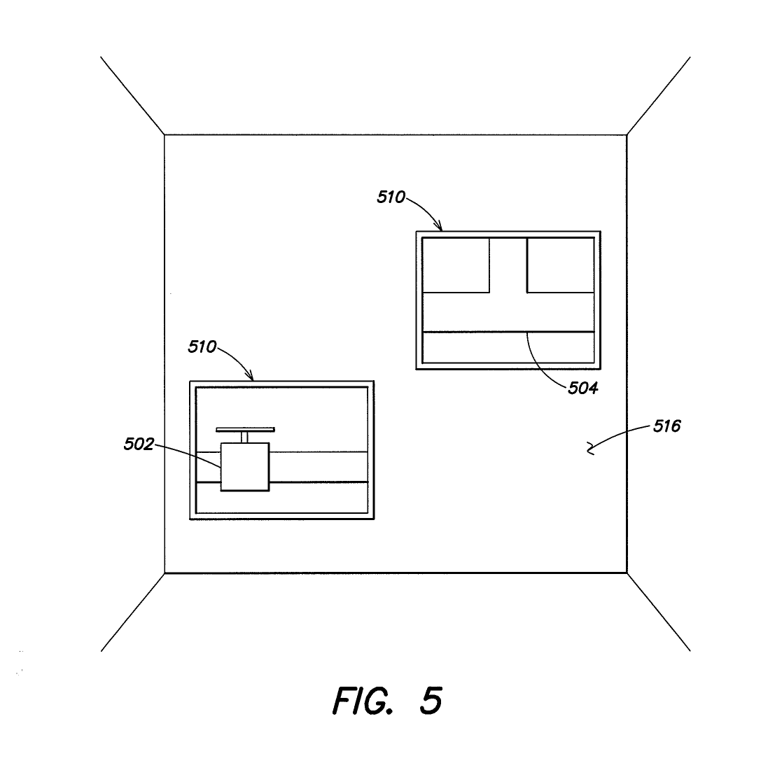

Similar to the pendulum example of FIG. 4, in which only portions of a larger image are “exposed” by the display unit at any given time, embodiments of the methods and systems disclosed herein may be used to virtually “view” various components hidden behind opaque surfaces. For example, referring to FIG. 5, plumbing components, such as a valve 502 or a pipe tee 504, are installed behind a wall 516. Before wall 516 is installed, a representation (such as a drawing or photograph) of the installed components is constructed, and the representation is indexed to one or more reference points within the room or some reference frame relative to the environment of the room. After the wall is installed, a display unit, such as a portable LCD screen 510, may be held in front of the wall and moved across the wall surface, and display screen 510 displays the components that can be found behind the wall at respective different locations along the wall surface. The information regarding the components (e.g., the drawing or photograph) may be loaded onto a controller that is present within the display unit assembly, or the information may be dynamically linked to the display unit assembly via a wire or wireless connection.

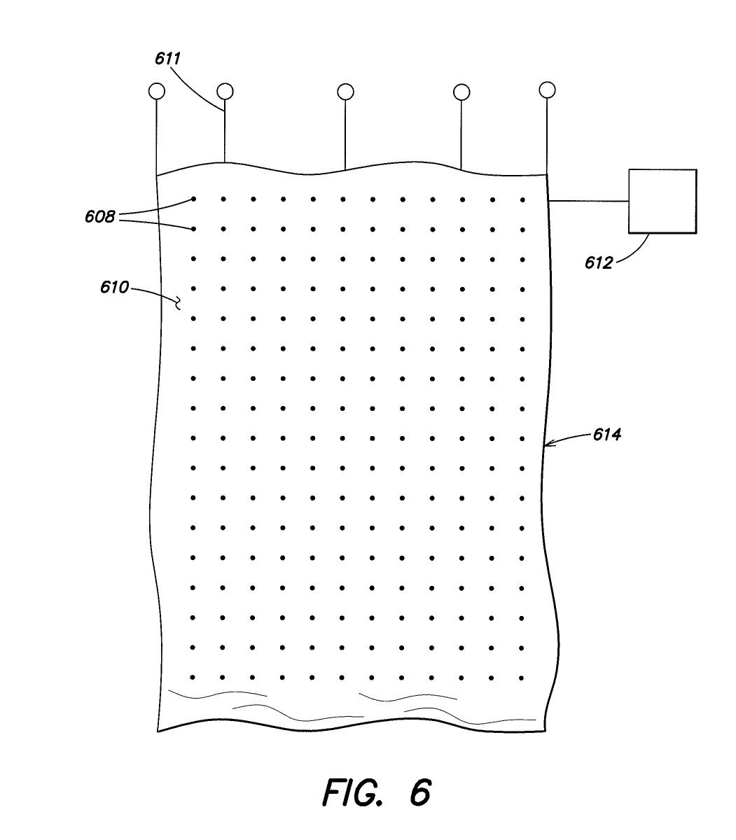

FIG. 6 illustrates a particular application for the methods and systems disclosed herein wherein LEDs 608 are positioned throughout a flexible fabric 610, such as a drapery, to provide a low resolution display device (e.g., wherein the LEDs serve as respective “pixels” of the display device). As the fabric is moved (e.g., lowered by a counterweight rigging system or a motorized rigging system 611), a controller 612 controls the LEDs such that the image remains stationary based on the determined position of fabric 610. For example, sensors may directly sense the position of the fabric such that unintentional and/or unpredictable movements of the fabric also may be incorporated into calculations of image display. Various subsections of the fabric may have their positions independently sensed to accommodate movements of sections of the fabric. For example, a lower corner 614 of fabric 610 may flutter due to wind while the remainder of fabric 610 remains stationary. In such a case, controller 612 may adjust the display in lower corner 614 only based on the sensed movement of the lower corner.

A dynamic drapery as discussed above in connection with FIG. 6 may allow audiences to enjoy a familiar fiber optic star field background, and subsequently, color graphics and low resolution video may be projected from the drapery. These aspects may be implemented with a Lightscape™ curtain available from Main Light Industries, Inc. of Wilmington, Del. In one implementation, the respective LEDs serving as pixels in the low-resolution drapery display unit may be multicolor (e.g., RGB) LED sources controlled via a serial communication protocol, as described in U.S. Pat. No. 6,777,891, hereby incorporated herein by reference.

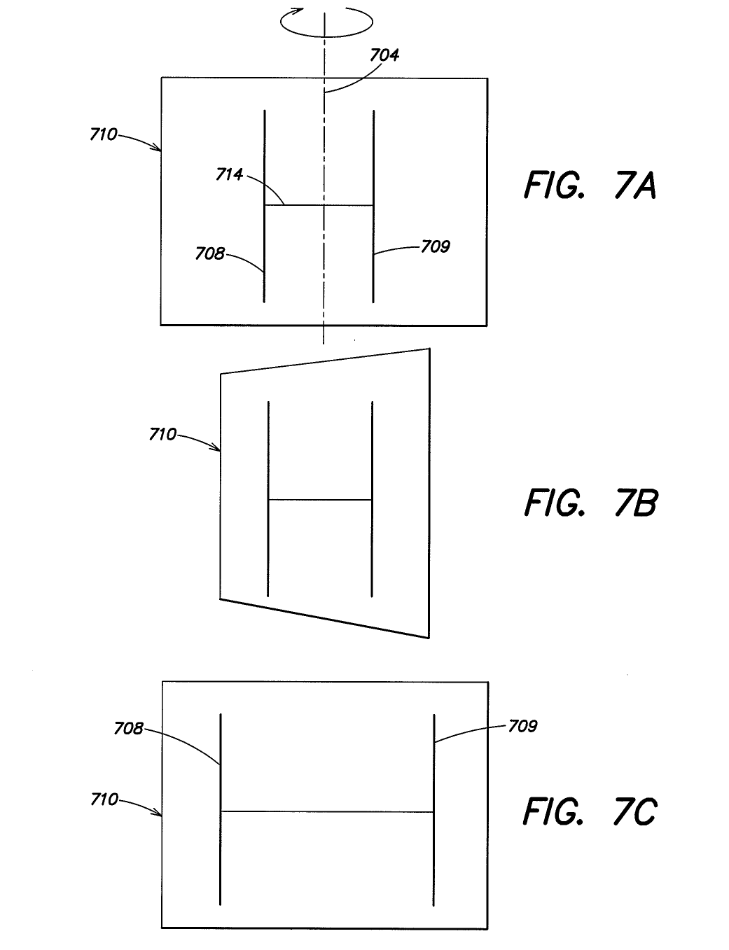

FIGS. 7a-7c illustrate a display unit 710 which maintains a steady appearance of a display image 714 when display unit 710 is subject to a yaw rotation. In this embodiment, when display unit 710 is rotated about a vertical axis 704, the position and orientation of displayed image 714 appear to stay constant to a viewer positioned in front of display unit 710 when display unit 710 is in the orientation of FIG. 7a. As display unit 710 rotates about vertical axis 704, the extent of rotation is determined and a controller calculates an appropriate image adjustment. In the case of displayed letter “H” in this embodiment, as can be seen in FIG. 7c, the left vertical line 708 of the H is lengthened and the right vertical line 709 of the H is shortened so that both lines appear to be the same length when display unit 710 is viewed from the same vantage point as in FIG. 7a, but with display unit 710 rotated, as shown in FIG. 7b. Additionally, both vertical lines 708, 709 are thickened to compensate for the thinning that occurs when viewing the lines from an angle.

In the implementations shown and described with reference to FIGS. 7a-7c, it is assumed that the vantage point is constant and is such that display unit 710 is perpendicular to the viewing line in its initial position. The present invention contemplates, however, that the vantage point may be at a different position relative to display unit 710 at the display unit's initial orientation, and/or the vantage point may change during viewing. In either case, in one embodiment the system may be configured to determine the position and/or orientation of the viewer, and adjust the displayed image accordingly.

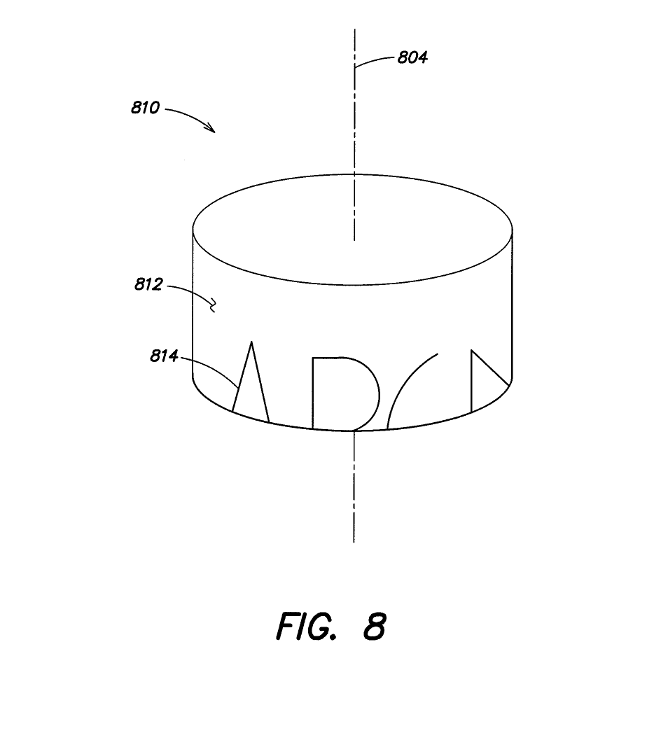

In another embodiment, the display unit on which an image is displayed need not be essentially planar. FIG. 8 illustrates one example of a non-planar display unit 810 according to such an embodiment. In this embodiment, a cylindrical surface 812 displays an image 814. As the cylindrical surface moves up or down, or rotates about a vertical axis 804, displayed image 814 may be held constant relative to the physical surroundings of display unit 810. For example, in some applications, including an electronic “tickertape,” displayed image 814 may move horizontally around cylindrical surface 812 at a constant rate. In such embodiments, when movement of the display surface occurs in the vertical direction, the system may be configured to continue displaying the image with horizontal movement, but maintain the vertical position of the horizontally scrolling image. The cylindrical display unit may rotate about vertical axis 804, and the system may accordingly adjust the image display so that the horizontal scrolling maintains its initial rate of horizontal movement.

A system configuration which allows the intended movements of a displayed image to progress as intended regardless of changes in the position or orientation of the display unit may be employed with other implementations of the technology described herein, and need not be restricted to cylindrical or other non-planar surfaces. For example, the implementation illustrated in FIGS. 1a-1c and discussed above may be used to display an animation rather than a static image. In such an application, even as display unit 110 moves, the animation remains in the same initial position.

The present invention further contemplates that displayed images (whether static or animated) may move in response to movement of the display unit, but with a delay or lag time. For example, in the implementation illustrated in FIGS. 1a-1c, as display unit 110 moves to the left, displayed image 114 may also move to the left, but with a slower speed and/or with a delayed start time.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Various embodiments of the present invention are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “ccontaining,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of displaying an image, the method comprising:
A) displaying the image on a display unit, the image being in a first image position relative to a reference frame, the image being in a first image orientation relative to the reference frame, the display unit being in a first display unit position and a first display unit orientation relative to the reference frame;
B) moving the display unit to a second display unit position and/or a second display unit orientation relative to the reference frame;
C) determining the second display unit position and/or the second display unit orientation;
D) based on C), calculating a target position and/or a target orientation for at least a portion of the image relative to the display unit such that in the target position and/or the target orientation, at least the portion of the image remains substantially in the first image position and/or the first image orientation relative to the reference frame; and
E) displaying at least the portion of the image on the display unit in the target position and/or the target orientation.

2. The method of claim 1, wherein:
B) comprises moving the display unit to the second display position;
C) comprises determining the second display position; and
D) comprises calculating the target position for at least the portion of the image.

3. The method of claim 1, wherein:
B) comprises moving the display unit to the second display orientation;
C) comprises determining the second display orientation; and
D) comprises calculating the target orientation for at least the portion of the image.

4. The method of claim 3, wherein B) comprises rotating the display unit about an axis that is substantially perpendicular to the display unit.

5. The method of claim 3, wherein B) comprises rotating the display unit about an axis that is either parallel to the display unit or contained substantially within the display unit.

6. The method of claim 1, wherein C) comprises directly sensing the second display position and/or the second display orientation.

7. The method of claim 1, wherein C) comprises estimating the second display position and/or the second display orientation.

8. The method of claim 1. wherein C) comprises determining the second display position and/or the second display orientation via dead-reckoning.

9. The method of claim 1, wherein the display unit comprises a plurality of separately controllable LEDs attached to a material substrate, and wherein E) comprises displaying at least the portion of the image via the plurality of LEDs.

10. The method as in claim 1, wherein:
D) comprises calculating the target position and/or the target orientation for the entire image; and
E) comprises displaying the entire image in the target position and/or the target orientation for the entire image.

11. A system for displaying an image, the system comprising:
a display unit; and
a controller coupled to the display unit and configured to instruct the display unit to display an image such that the image remains in substantially a same position and/or orientation, relative to physical surroundings of the display unit, notwithstanding a movement of the display unit relative to the physical surroundings.

12. The system of claim 11, wherein the controller is configured to instruct the display unit to display the image in a first image position and a first image orientation relative to a reference frame when the display unit is in a first display unit position and a first display unit orientation relative to the reference frame, and wherein the controller is configured to calculate a target position and/or a target orientation for at least a portion of the image relative to the display unit such that in the target position and/or the target orientation, at least the portion of the image remains substantially in the first image position and/or the first image orientation relative to the reference frame when the display unit is moved to a second display unit position and/or a second display unit orientation relative to the reference frame.

13. The system of claim 12, wherein the controller is configured to directly sense the second display position and/or the second display orientation.

14. The system of claim 12, wherein the controller is configured to estimate the second display position and/or the second display orientation.

15. The system of claim 12, wherein the controller is configured to determine the second display position and/or the second display orientation via dead-reckoning.

16. The system of claim 12, wherein the display unit comprises a plurality of separately controllable LEDs attached to a material substrate, and wherein the display unit displays at least the portion of the image via the plurality of LEDs.

17. The system of claim 12, wherein the controller is configured to calculate the target position and/or the target orientation for the entire image and control the display unit so as to display the entire image in the target position and/or the target orientation for the entire image.

18. A method of displaying an image, the method comprising:
A) storing information regarding an image to be displayed, wherein an image position and/or image orientation is determined with respect to a fixed reference frame; and
B) progressively displaying different portions of the image, based at least in part on the stored information, via a display unit that is moving with respect to the fixed reference frame, wherein the image position and/or image orientation remains unchanged with respect to the fixed reference frame.

19. The method of claim 18, wherein B) comprises:
displaying a first portion of the image, the first portion corresponding to a first position of the display unit relative to the fixed reference frame;
moving the display unit to a second position relative to the fixed reference frame; and
displaying a second portion of the image, the second portion corresponding to the second position of the display unit relative to the fixed reference frame.

20. The method of claim 18, wherein the image includes one or more features disposed on a first side of an opaque material, and wherein the display unit is disposed on a second side of the opaque material and moved with respect to a surface of the second side of the opaque material.
